(19) United States
(12) Patent Application Publication
(10) Pub. No.: US 2006/0231664 A1
(43) Pub. Date: Oct. 19, 2006

(54) Seat belt retractor and seat belt device

(75) Inventors: Masato Takao, Tokyo (JP); Koji Tanaka, Tokyo (JP); Koji Inuzuka, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/401,958

(22) Filed: Apr. 12, 2006

(30) Foreign Application Priority Data
Apr. 14, 2005 (JP) 2005-117121

(51) Int. Cl. B60R 22/46

(52) U.S. Cl. 242/374

(57) ABSTRACT

The disclosed seat belt retractor can be used in reducing the operational sound caused by the disconnecting operation of the power transmission mechanism when the power transmission mechanism is switched from a connected state to a disconnected state. The power transmission mechanism can be switched from a connected state to a disconnected state by a rotational speed difference between an electric motor and a spool so as to release the connection between the electric motor and the spool. The motor 6 can be controlled to be rotated at an operational sound reducing speed when the power transmission mechanism 8 is switched from the connected state to the disconnected state.

### BACKGROUND

The present invention relates to a seat belt retractor mounted on a vehicle.

In the related art, a seat belt device is known to protect a vehicle occupant by using a seat belt, known as a “webbing,” for restraining the vehicle occupant. For example, Japanese PCT Publication No. 2003-507252 (hereinafter known as the “'252 publication”) discloses a structure for a seat belt retractor, which performs a retracting operation and a withdrawing operation on the seat belt by controlling an electric motor to rotate a spool. The '252 publication discloses a structure of the seat belt retractor and provides the possibility of the electric motor performing the retracting operation and the withdrawing operation using the spool. In addition, in the seat belt retractor in which the spool is operated by the electric motor, a power transmission mechanism is interposed between the electric motor and the spool. The power transmission mechanism is switched from a connected state to a disconnected state by a rotational speed difference between the electric motor and the spool so that the connection between the electric motor and the spool is released.

In a structure in which the power transmission mechanism is interposed between the electric motor and the spool, like the above-mentioned seat belt retractor, when the power transmission mechanism is switched from the connected state to the disconnected state, operational sound occurs due to the idle running of the electric motor.

The present disclosure addresses the problem described above. It is an object of the application to provide a technology useful in reducing the operational sound caused by the disconnecting operation of the power transmission mechanism in the seat belt retractor to be mounted on a vehicle in which the power transmission mechanism is switched from a connected state to a disconnected state by a rotational speed difference between the electric motor and the spool so as to release the connection between the electric motor and the spool.

Embodiments of the present invention can be configured to solve the above-mentioned problem. Although the invention can be typically applied to a seat belt retractor mounted on a vehicle such as an automobile, the invention can also be applied to a vehicle other than the automobile, for example an airplane, a ship, an electric train, etc.

### SUMMARY

The first embodiment of the present invention is a seat belt retractor in which the seat belt retractor may include at least a spool, an electric motor, a power transmission mechanism, and a control unit.

The spool can include a member for retracting or withdrawing the seat belt. The seat belt to be retracted or withdrawn by the spool can be a long belt (or webbing) fastened about a vehicle occupant. Typically, because the seat belt restrains the vehicle occupant seated in a vehicle seat during the vehicle collision, the vehicle occupant can be protected.

The power transmission mechanism may include a mechanism that is interposed between the electric motor and the spool. The power transmission mechanism can form a connected state in which the electric motor and the spool are connected to each other and a disconnected state in which the connected state is released. The power transmission mechanism can be called a “clutch” in which gear members are combined.

The connected state of the power transmission mechanism can be a state in which the spool is mechanically connected to the power transmission mechanism so that the power of the electric motor can be transmitted to the spool through the power transmission mechanism. Accordingly, when the electric motor is driven in the connected state, the power of the electric motor is transmitted to the spool through the power transmission mechanism. In addition, when the electric motor is stopped in the connected state, the power of the electric motor is not transmitted to the spool. However, since a high withdrawal resistance is applied to the spool due to the power transmission mechanism mechanically connected to the spool, a state is formed in which the withdrawal of the seat belt from the spool is regulated. Specifically, in this state, it is difficult, if not impossible, to withdraw the seat belt.

Correspondingly, in the disconnected state of the power transmission mechanism, it is possible to easily withdraw the seat belt from the spool because the withdrawal resistance from the power transmission mechanism mechanically disconnected to the spool is lowered regardless of the driving or stopping of the electric motor.

The control unit may include a unit that controls the electric motor and the power transmission mechanism and it controls the electric motor to be switched between the driving and the stopping. Furthermore, the control unit can control the power transmission mechanism to switch between the connected state and the disconnected state. The control unit may typically be composed of a CPU (central processing unit), input and output units, a memory unit, peripheral units, etc. The control unit may be used to solely control the seat belt retractor or it may also be used as control unit for controlling other systems, such as a driving system or an electrical system of the vehicle.

Moreover, when the electric motor is controlled to be rotated in a first direction in the connected state of the power transmission mechanism, the spool can be controlled to be rotated in the belt retracting direction, and thus the seat belt is retracted. When the electric motor is controlled to be rotated in a second direction opposite to the first direction so as to switch the power transmission mechanism from the connected state to the disconnected state, the power transmission mechanism is switched from the connected state to the disconnected state by a rotational speed difference between the electric motor and the spool.

In the structure in which the power transmission mechanism is switched from the connected state to the disconnected state by a rotational speed difference between the electric motor and the spool like the seat belt retractor according to one embodiment of the present invention, when the power transmission mechanism is switched from the connected state to the disconnected state, operational sound occurs due to the idle running of the electric motor.

Accordingly, in the first embodiment of the seat belt retractor, in order to reduce the operational sound caused by the switching operation of the power transmission mechanism, when the power transmission mechanism is switched from the connected state to the disconnected state, the control unit controls the electric motor so that the electric motor is rotated in the second direction at an operational sound reducing speed corresponding to the switching operation. The operational sound reducing speed can be defined as a speed useful in reducing the operational sound, which is caused by the switching operation of the power transmission mechanism. The operation sound reducing speed can be properly set in accordance with the assumed operational sound level. In addition, the operational sound reducing speed may have a specific speed value or may have any speed value within a predetermined speed range.

According to the structure of the seat belt retractor according to the first embodiment, it is possible to reduce the operational sound caused by the disconnecting operation of the power transmission mechanism.

A second embodiment of the present invention can be a seat belt retractor in which the seat belt retractor includes a detecting unit. The detecting unit may include a unit capable of detecting whether the power transmission mechanism is in the connected state or the disconnected state. Structures that can be used as the detecting unit may include a structure that uses a hall IC or a structure in which a state of the power transmission mechanism is detected on the basis of the motor load corresponding to a detected current value, which is detected by a sensor for detecting a current value of the electric motor.

In addition, when it is determined that the power transmission mechanism is in the connected state, the control unit can control the electric motor so that the electric motor is rotated in the second direction at a higher speed than the operational sound reducing speed.

According to the structure of the second embodiment of the seat belt retractor, it is possible to reduce the operational sound caused by the disconnecting operation of the power transmission mechanism and to reliably switch the power transmission mechanism to the disconnected state. That is, assuming that the occupant applies a tensile force to the seat belt, and thus the spool is rotated in the belt withdrawing direction, since the rotational speed difference between the electric motor and the spool does not sometimes occur, the power transmission mechanism may not be switched to the disconnected state. However, the second embodiment of the invention may be useful in reliably switching the power transmission mechanism to the disconnected state.

A third embodiment of the invention for can be a seat belt retractor in which the detecting unit includes a motor current detector for detecting a current value of the electric motor. In addition, when the current value detected by the motor current detector is larger than a reference current value, the control unit determines that the power transmission mechanism is in the connected state because the load of the motor is relatively high. In the meantime, when the current value detected by the motor current detector is smaller than the reference current value, the control unit determines that the power transmission mechanism is in the disconnected state because the load of the motor is relatively low. Accordingly, the reference current value is properly set on the basis of the motor current value when the power transmission mechanism is in the connected state or in the disconnected state.

Therefore, according to the structure of the third embodiment of the seat belt retractor, it is possible to use the motor current detector for detecting the current value of the electric motor as a unit for detecting whether the power transmission mechanism is in the connected state or the disconnected state.

A fourth embodiment can be a seat belt device, which may include at least a seat belt, a spool, an electric motor, a power transmission mechanism, and a control unit. The seat belt (or webbing), may be a long belt fastened about a vehicle occupant. Typically, since the seat belt restrains the vehicle occupant seated in a vehicle seat during the vehicle collision, the vehicle occupant can be protected. The spool, the electric motor, the power transmission mechanism, and the control unit of the fourth embodiment of the present invention can be substantially the same as those of the seat belt retractor of any of the previously-mentioned embodiments of the present invention.

Therefore, according to the fourth embodiment of the present invention, it is possible to provide a seat belt device capable of reducing the operational sound caused by the disconnecting operation of the power transmission mechanism.

A fifth embodiment of the present invention can be a seat belt device, which may include a detecting unit. The detecting unit may include a unit capable of detecting whether the power transmission mechanism is in the connected state or the disconnected state. Structures that can be properly used as the detecting unit may include a structure using a hall IC or a structure in which a state of the power transmission mechanism is detected on the basis of the motor load corresponding to the detected current value detected by use of a sensor for detecting a current value of the electric motor.

In addition, when it is determined that the power transmission mechanism is in the connected state, the control unit controls the electric motor so that the electric motor is rotated in the second direction at a higher speed than the operational sound reducing speed.

According to the structure of the fifth embodiment, it is possible to reduce the operational sound caused by the disconnecting operation of the power transmission mechanism and to reliably switch the power transmission mechanism to the disconnected state. That is, assuming that the occupant applies a tensile force to the seat belt, and thus the spool is rotated in the belt withdrawing direction, since the rotational speed difference between the electric motor and the spool does not sometimes occur, the power transmission mechanism may not be switched to the disconnected state. However, the fifth embodiment of the invention is useful in reliably switching the power transmission mechanism to the disconnected state.

A sixth embodiment of the present invention can be a seat belt device, which may include a motor current detector for detecting a current value of the electric motor. In addition, when the current value detected by the motor current detector is larger than a reference current value, the control unit determines that the power transmission mechanism is in the connected state because the load of the motor is relatively high. In the meantime, when the current value detected by the motor current detector is smaller than the reference current value, the control unit determines that the power transmission mechanism is in the disconnected state because the load of the motor is relatively low. Accordingly, the reference current value is properly set on the basis of the motor current value when the power transmission mechanism is in the connected state or in the disconnected state.

Therefore, according to the structure of the sixth embodiment, it is possible to use the motor current detector for detecting the current value of the electric motor as a unit for detecting whether the power transmission mechanism is in the connected state or the disconnected state.

A seventh embodiment of the present invention can be a vehicle with a seat belt device, which can include at least the seat belt device disclosed in any previous embodiments of the present invention. The vehicle of the seventh embodiment can be a seat belt device received in a receiving space of the vehicle, for example, the receiving space within a pillar, the receiving space within a seat, or the receiving space of other portions of the vehicle.

According to the structure of the vehicle with the seat belt device, it is possible to provide a vehicle with a seat belt device in the receiving space of the vehicle, which can reduce the operational sound caused by the disconnecting operation of the power transmission mechanism.

As described above, according to various embodiment of the present invention, the power transmission mechanism of a seat belt retractor is switched from the connected state to the disconnected state by a rotational speed difference between the electric motor and the spool so that the connection between the electric motor and the spool is released. Particularly, when the power transmission mechanism is switched from the connected state to the disconnected state, the motor can be controlled to rotate at an operational sound reducing speed corresponding to the switching operation. Thus, it is possible to reduce the operational sound caused by the disconnecting operation of the power transmission mechanism.

It is to be understood that both the foregoing general description and the following detailed descriptions are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 shows a schematic structure of a seat belt device according to an embodiment of the present invention.

FIG. 2 shows a schematic structure of the surrounding structure of the seat belt retractor according to an embodiment of the present invention.

FIG. 3 shows an exploded perspective view of the seat belt retractor according to an embodiment of the present invention.

FIG. 4(a) shows a perspective view in which the retainer cover is removed from the seat belt retractor and FIG. 4(b) shows the left side view of FIG. 4(a).

FIG. 5(a) shows a perspective view of a sun gear member used in the seat belt retractor and FIG. 5(b) shows a perspective view of the sun gear member as seen from the IIIB side of FIG. 5(a).

FIG. 6 shows a left side view of the seat belt retractor in a power interruption mode.

FIG. 7 shows a left side view of the seat belt retractor in a low speed reduction ratio power transmission mode.

FIG. 8 shows a left side view of the seat belt retractor in a high speed reduction ratio power transmission mode.

FIG. 9 shows a flow chart of the retractor control process for the seat belt retractor according to an embodiment of the present embodiment.

### DETAILED DESCRIPTION

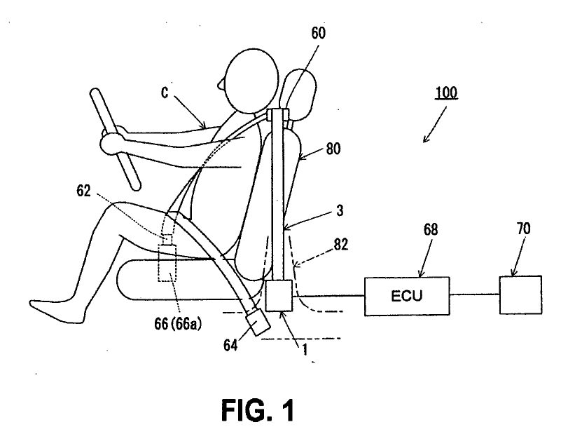

Hereinafter, various embodiments of the invention will be described in detail by referring to the accompanying drawings. First, embodiments of the present invention will be described with reference to FIGS. 1 to 4.

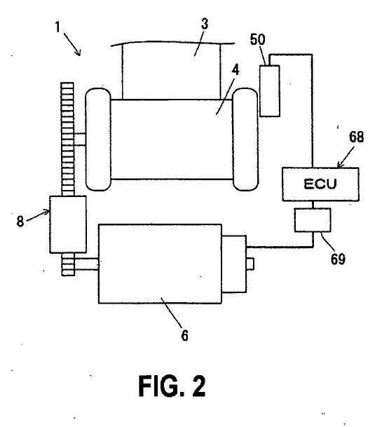

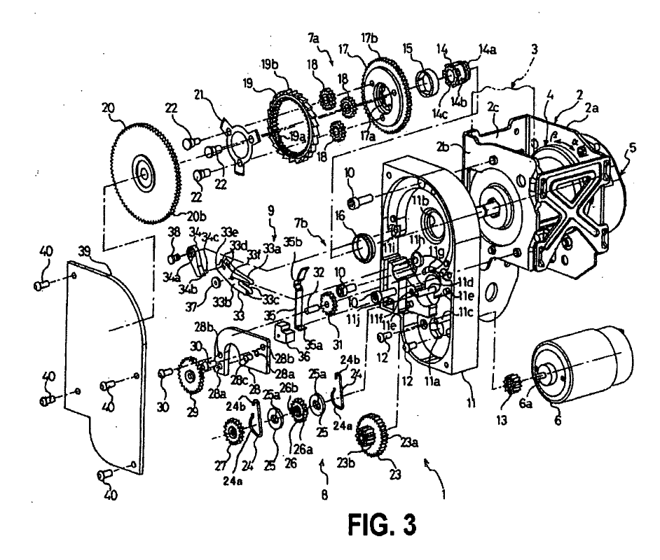

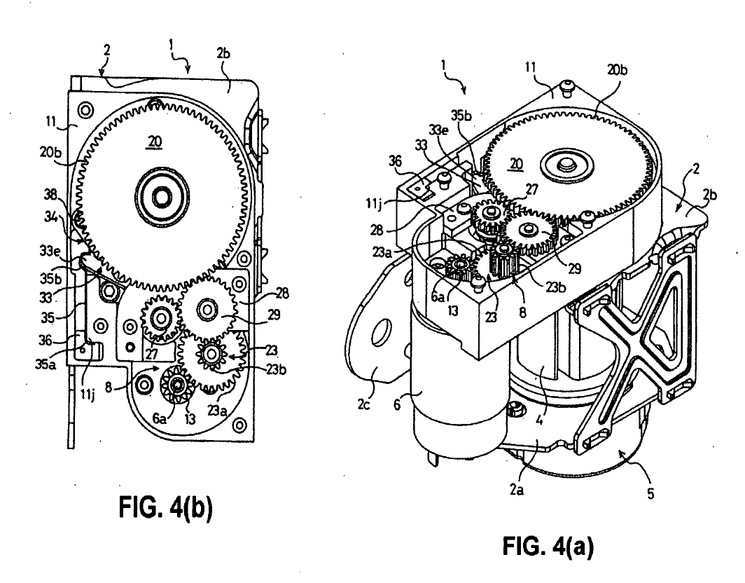

FIG. 1 shows a schematic structure of a seat belt device 100 according to an embodiment of the present invention; FIG. 2 is a view showing the surrounding structure of a seat belt retractor 1 shown in FIG. 1; and FIG. 3 shows an exploded perspective view of the seat belt retractor 1 according to an embodiment of the invention. In addition, FIG. 4(a) shows a perspective view showing a state in which the retainer cover is removed from the seat belt retractor 1 shown in FIG. 3 and FIG. 4(b) is a left side view of FIG. 4(a). In the following description, as long as it is particularly not limiting, the directions “left” and “right” indicate the “left” and “right” directions in the drawings used for the description. Furthermore, the “clockwise direction” and the “counter-clockwise direction” indicate the “clockwise direction” and the “counter-clockwise direction” in the drawings used for the description.

As shown in FIG. 1, the seat belt device 100 of this embodiment is a seat belt device for a vehicle, which is mounted on a vehicle, i.e., a “vehicle with a seat belt device.” The seat belt device 100 can be mainly formed of a seat belt retractor 1, a seat belt 3, and an ECU 68. In addition, the vehicle is provided with an input element 70. The input element 70 may detect various types of information, such as information about a collision prediction or collision occurrence of the vehicle, the driving state of the vehicle, the seating position or the physique of a vehicle occupant seated on the seat, the surrounding traffic conditions, and the weather or the time zones. The input element 70 inputs the detected information into the ECU 68. The detected information of the input element 70 can transmitted to the ECU 68 continuously or at predetermined times so that the detected information of the input element 70 can be used in the controlling operation of the seat belt device 100 or the like.

A seat belt 3 can be a long belt (or webbing), which is used for restraining or releasing the vehicle occupant C seated on the vehicle seat 80, such as the driver's seat. The seat belt 3 can correspond to a “seat belt” of the present disclosure. The seat belt 3 is extracted from a seat belt retractor 1 fixed to the vehicle. The seat belt 3 can be connected to an out anchor 64 through a shoulder guide anchor 60 provided in a portion of the safety device corresponding to the shoulder of the vehicle occupant C and through a tongue 62. The shoulder guide anchor 60 functions to lock and to guide the seat belt 3 in the portion of the safety device that corresponds to the shoulder of the vehicle occupant C. The seat belt 3 is fastened about the vehicle occupant C by inserting the tongue 62 into a buckle 66 fixed to the vehicle body. Furthermore, the buckle 66 is provided with a buckle switch 66a. The buckle switch 66a may detect the operation of the seat belt buckle (the mounted state of the seat belt) by detecting the insertion of the tongue 62 into the buckle 66.

The seat belt retractor 1 can be a unit capable of retracting and withdrawing the seat belt 3 via a spool 4 to be described below. The seat belt retractor 1 can correspond to a “seat belt retractor” of the present disclosure. As shown in FIG. 1, the seat belt retractor 1 can be mounted in a receiving space, which may be formed in a B pillar 82 of the vehicle.

The ECU 68 can have a function to control the seat belt retractor 1 and various operating mechanisms on the basis of the signals from the input element 70. The ECU 68 can be formed of a CPU (central processing unit), input and output units, a memory unit, peripheral units, etc. In the description of the present embodiment, in particular, the ECU 68 may control a motor 6, to be described below, of the seat belt retractor 1. Specifically, since the ECU 68 controls a supply amount or a supply direction of the current supplied to an electromagnetic coil of the motor 6, the rotational speed and the rotational direction of a motor shaft are varied. As described in detail below, the ECU 68 controls the driving of the motor 6 and serves as a unit for switching the state in which a driving force of the motor 6 is transmitted to the spool 4 by controlling a power transmission mechanism 8 and a power transmission mode switching mechanism 9. The ECU 68 may correspond to a “control unit” of the present disclosure. The seat belt retractor 1 can be controlled to switch to a power interruption mode, a low speed reduction ratio power transmission mode, or a high speed reduction ratio power transmission mode by the ECU 68. In addition, the ECU 68 may be provided only to the seat belt retractor 1 or may be also used as a control unit for controlling another system, such as a driving system or an electrical system of the vehicle.

As shown in FIG. 2, the seat belt retractor 1 is provided with a detecting sensor 50 for directly detecting information on the rotation of the spool 4. The detecting sensor 50 is a sensor for detecting the operational information on the rotation of the spool 4. The motor 6 can be controlled by the ECU 68 on the basis of the detected information detected by the detecting sensor 50. Whether or not the spool 4 is rotated, the rotational angle, the rotational direction, the rotational speed, and the amount of rotation can be appropriately used as the detected information detected by the detecting sensor 50. A sensor, such as a hall sensor, a volume sensor, or a photo interrupter, can be appropriately used as the detecting sensor 50.

Hereinafter, the seat belt retractor 1 according to an embodiment of the present invention will be described in detail.

As shown in FIG. 3, the seat belt retractor 1 can mainly include a frame 2, a seat belt 3 for restraining the vehicle occupant as needed, a spool 4 for retracting the seat belt 3, a lock unit 5 provided on one side of the frame 2, a motor 6 for generating the rotational torque to be applied to the spool 4, a power transmission mechanism 8, and a power transmission mode switching mechanism 9. The lock unit 5 is operated to prevent the spool 4 from being rotated in the belt withdrawing direction α at the time when a deceleration larger than a predetermined deceleration such as a collision occurs. The power transmission mechanism 8 has a speed reduction mechanism 7a and a speed reduction mechanism 7b. The speed reduction mechanism 7a has a high speed reduction ratio, which reduces the rotational speed of the motor 6 at a relatively high speed reduction ratio and then transmits the rotational speed to the spool 4. The speed reduction mechanism 7b has a low speed reduction ratio, which reduces the rotational speed of the motor 6 at a relatively low speed reduction ratio and then transmits the rotational speed to the spool 4. The power transmission mechanism 8 has a first power transmission path and a second power transmission path set therein so as to selectively transmit the rotational torque of the motor 6 to the spool 4 through any one of the first power transmission path and the second power transmission path. The power transmission mode switching mechanism 9 selectively switches the power transmission mechanism 8 to any one of the first power transmission path and the second power transmission path.

The power transmission mechanism 8 and the power transmission mode switching mechanism 9 are provided between the motor 6 and the spool 4 to construct a unit (so-called “clutch”) for forming a connected state or a disconnected state between the motor 6 and the spool 4 and can correspond to a “power transmission mechanism” of the present disclosure. In the connected state, the power of the motor 6 can be transmitted to the spool 4. The driving force of the motor 6 is transmitted to the spool 4 by driving the motor 6. Furthermore, in the connected state, when the motor 6 is stopped, a large withdrawal resistance is applied to the spool 4. Thus, the seat belt enters into a state in which a withdrawal thereof from the spool is regulated. Correspondingly, in the disconnected state, the seat belt 3 can be easily withdrawn from the spool 4 due to the withdrawal resistance being lowered.

The frame 2 is formed of a pair of sidewalls 2a and 2b that are disposed parallel to each other and a backboard 2c for connecting the sidewalls 2a and 2b to each other. The spool 4 for retracting the seat belt 3 is rotatably provided between the sidewalls 2a and 2b in the frame 2. A spool of the seat belt retractor 1, which is known in the related art, can be used as the spool 4. The spool 4 includes a member for retracting and withdrawing the seat belt and can correspond to a “spool” of the present disclosure.

A lock unit 5 is mounted on one sidewall 2a. A lock unit of a seat belt retractor, which is known in the related art, can be used as the lock unit 5. That is, for example, when a vehicle sensor detects that the deceleration applied to the vehicle is larger than a predetermined deceleration (a deceleration detecting sensor) or when a webbing sensor detects that a withdrawal speed of the seat belt 3 is higher than a predetermined speed (a belt withdrawal speed detecting sensor), the lock unit 5 is operated to prevent the spool 4 from rotating in the belt withdrawing direction α.

Furthermore, although not shown, a force limiter mechanism, such as an energy absorbing mechanism (hereinafter referred to as an “EA mechanism”), which is known in the related art, is provided between the spool 4 and the lock unit 5. When the seat belt 3 is prevented from withdrawing by the lock unit 5, the force limiter mechanism limits the load of the seat belt 3. For example, a torsion bar, which is known in the related art, can be used as the EA mechanism. When the seat belt 3 is prevented from withdrawing by the operation of the lock unit 5, the torsion bar is twisted and deformed so that the load of the seat belt 3 is limited and impact energy is absorbed.

As shown in FIGS. 3 and 4(a), the motor 6 is mounted on the surface of the retainer 11 facing the frame 2 with a pair of screws 12. In this case, the retainer 11 is mounted on the other sidewall 2b of the frame 2 with three screws 10. A motor rotary shaft 6a of the motor 6 passes through a through-hole 11a of the retainer 11. A motor gear 13 having external teeth is mounted on the motor rotary shaft 6a, which protrudes toward the opposite side to the surface of the retainer 11 facing the frame 2, and rotates with the motor rotary shaft 6a as one unit. The motor 6 is composed an electric motor and can correspond to an “electric motor” of the present disclosure.

As shown in FIG. 3, a connector 14 is provided between both the spool 4 and the above-mentioned EA mechanism (for example, a torsion bar) and the speed reduction mechanisms 7a and 7b for connecting them in the rotational direction. The connector 14 includes a first rotatable connecting part 14a that is connected to both the spool 4 and the EA mechanism in the rotational direction thereof; a second rotatable connecting part 14b that is connected to a connector bearing 15 in the rotational direction thereof; and a third rotatable connecting part 14c that is formed in a spline-shape and is connected to the speed reduction mechanisms 7a and 7b in the rotational direction thereof.

Although not clearly shown in FIG. 3, the first rotatable connecting part 14a is formed in a polygonal tube shape. An outer surface of the first rotatable connecting part 14a is connected to the spool 4 so as to be rotated with the spool 4 as one unit. An inner surface of the first rotatable connecting part 14a is connected to the EA mechanism (for example, a torsion bar) so as to be rotated with the EA mechanism as one unit. Since the rotatable connection structure between the first rotatable connecting part 14a and the connector 14, the spool 4, and the EA mechanism are known in the related art, the detailed description thereof is omitted here.

The outer surface of the second rotatable connecting part 14b is formed in a polygonal shape. The inner surface of the connector bearing 15 is formed in the same polygonal shape as the outer surface thereof. The connector bearing 15 is fitted to the second rotatable connecting part 14b so as to be mounted on the connector 14 so that the connector bearing 15 cannot be rotated relative to the connector 14. Since the connector bearing 15 is rotatably supported relative to a retainer bearing 16, which is mounted in a hole 11b of the retainer 11 so as not to be capable of relative rotation, the connector 14 is rotatably supported in the retainer 11.

The third rotatable connecting part 14c has a predetermined number of engaging grooves, such as spline grooves, which extend in the axial direction thereof, at regular intervals in the circumferential direction thereof.

The speed reduction mechanism 7a having a high speed reduction ratio includes an annular carrier gear 17, a predetermined number (for example, three are shown in FIG. 3) of planet gears 18 rotatably mounted on the carrier gear 17, an annular ring member 19, and a sun gear member 20.

The predetermined number of engaging grooves, such as spline grooves, which extend in the axial direction thereof, are formed on the inner circumferential surface 17a of the carrier gear 17 facing the connector 14 in the circumferential direction thereof at regular intervals. The engaging grooves formed on the inner circumferential surface 17a are engaged with the protrusions formed between the engaging grooves of the third rotatable connecting part 14c. In addition, the protrusions formed between the engaging grooves of the inner circumferential surface 17a are engaged with the engaging grooves of the third rotatable connecting part 14c (engagement such as spline engagement). Accordingly, the carrier gear 17 is connected to the connector 14 so as not to be rotated relative to the connector 14.

That is, the carrier gear 17 is rotated with the connector 14 as one unit. Also, the external teeth 17b are formed on the outer circumferential surface of the carrier gear 17.

The planet gears 18 can be rotatably mounted on the carrier gear 17 with the speed reduction pins 22 and a speed reduction plate 21 interposed therebetween.

The ring member 19 has an internal gear 19a formed on the inner circumferential surface thereof and ratchet teeth 19b formed on the outer circumferential surface thereof. The internal gear 19a and the ratchet teeth 19b are rotated as one unit.

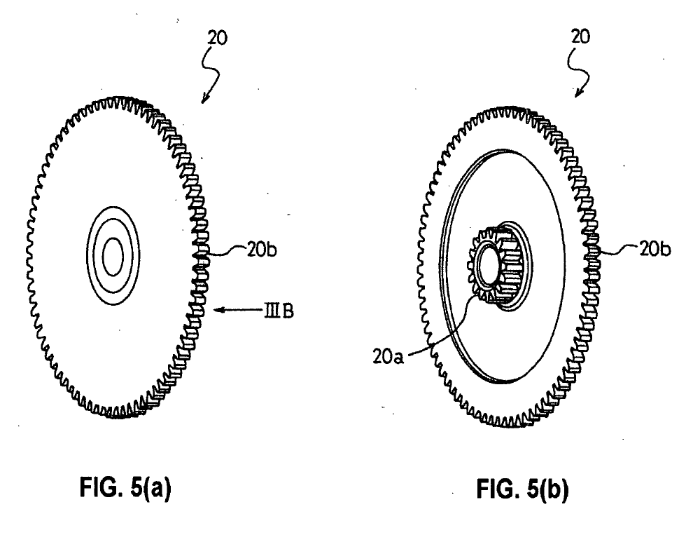

As shown in FIGS. 5(a) and 5(b), the sun gear member 20 can be provided with a sun gear 20a, which is composed of small diametric external teeth, and large diametric external teeth 20b. The sun gear 20a and the external teeth 20b are rotated as one unit.

When each of the planet gears 18 supported on the carrier gear 17 are engaged with both the sun gear 20a and the internal gear 19a, the planetary mechanism is constructed. Accordingly, the speed reduction mechanism 7a having a high speed reduction ratio is composed of a planetary gear speed reduction mechanism in which an output of the carrier gear 17 is obtained by an input of the sun gear 20a.

In addition, as shown in FIG. 3, the power transmission mechanism 8 includes a connector gear 23, a pair of clutch springs 24, a pair of pulleys 25, a lower connector gear 26 having external teeth, an upper connector gear 27 having external teeth, a guide plate 28, and an idle gear 29 having external teeth.

The connector gear 23 is rotatably supported by a rotary shaft 11c that stands on the retainer 11 and includes a first connector gear 23a that is composed of large diametric external teeth with a small diametric second connector gear 23b. The first and second connector gears 23a and 23b are rotated with each other as one unit. In this case, as shown in FIGS. 4(a) and 4(b), the large diametric first connector gear 23a is always engaged with the motor gear 13.

As shown in FIG. 3, rotary shafts 26a (only one rotary shaft 26 is shown in FIG. 3) protrude on both surfaces of the lower connector gear 26, and a through-hole 26b is formed to pass through the rotary shafts 26a in the axial direction thereof. Each of the rotary shafts 26a is formed with flat portions and is inserted into the slot 25a of the corresponding pulleys 25 so that the flat planes of the flat portions are fitted in the slot. For this reason, the pulleys 25 are supported on both surfaces of the lower connector gear 26 and are to be rotated with the lower connector gear 26 as one unit. The first curved locking portions 24a of the clutch springs 24 are locked on the pulleys 25. Furthermore, the upper connector gear 27 is supported on one rotary shaft 26a of the lower connector gear 26 and is to be rotated with the lower connector gear 26 as one unit. The pulleys 25, the lower connector gear 26, and the upper connector gear 27 are rotatably supported by a rotary shaft 11d that stands on the retainer 11.

A pair of supporting shafts 11e, which stand on the retainer 11, are correspondingly inserted into a pair of respective holes 28a formed on the guide plate 28 so that the guide plate 28 is supported by the supporting shafts 11e. Then, a pair of screws 30 are fastened into a pair of screw holes 11f, which are formed on the retainer 11 and run through corresponding screw holes of the guide plate 28 so as to mount the guide plate 28 on the retainer 11. The idle gear 29 is rotatably supported on a rotary shaft 28c that stands on the guide plate 28.

As shown in FIGS. 4(a) and 4(b), the idle gear 29 is always engaged with the external teeth 20b of the sun gear member 20, the small diametric second connector gear 23b of the connector gear 23, and the upper connector gear 27.

Furthermore, the speed reduction mechanism 7b having a low speed reduction ratio includes the upper connector gear 27, the lower connector gear 26, a clutch gear 31, and the carrier gear 17.

Accordingly, the rotational torque of the motor 6 transmitted to the idle gear 29 is transmitted to the spool 4 from the idle gear 29 through the speed reduction mechanism 7b having a low speed reduction ratio or is transmitted to the spool 4 from the idle gear 29 through the speed reduction mechanism 7a having a high speed reduction ratio.

As shown in FIG. 3, the power transmission mode switching mechanism 9 includes a clutch gear 31 having external teeth, a rotary shaft 32, a clutch arm 33, a clutch pawl 34, a resistance spring 35, and a spring stopper 36.

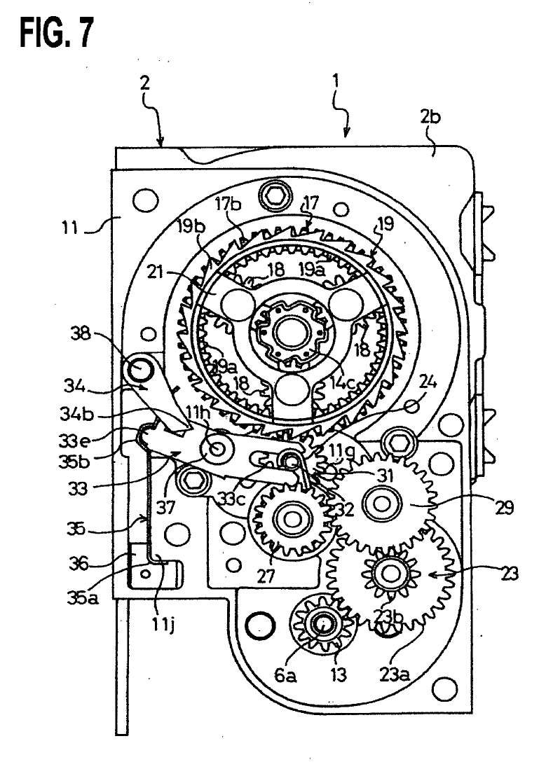

As shown in FIG. 7, the clutch gear 31 can be engaged with the external teeth 17b of the carrier gear 17, which has a diameter larger than that of the clutch gear 31. Furthermore, although not shown, the clutch gear 31 is always engaged with the lower connector gear 26. The clutch gear 31 is rotatably supported by the rotary shaft 32, which passes through a central hole 31a of the clutch gear 31.

The clutch arm 33 includes both sidewalls 33a and 33b and a bottom portion (not shown) so as to have a U-shaped cross-section. One end of the both sidewalls 33a and 33b protrudes from the bottom portions thereof, and the protruding portions have corresponding linear supporting grooves 33c. In addition, the clutch gear 31 is disposed between the protrusions of the sidewalls 33a and 33b. Both ends of the rotary shaft 32, which protrude from both surfaces of the clutch gear 31 are supported by the corresponding supporting grooves 33c so as to be moved along the supporting grooves 33c. In addition, the second curved locking portions 24b of the clutch springs 24 are locked on protruding portions of the rotary shaft 32, which protrude from the sidewalls 33a and 33b. Furthermore, one end of the rotary shaft 32 is inserted into a guide hole 11g, which is formed through the retainer 11, so as to be supported by the guide hole. The guide hole 11g has a shape of an arc of a circle whose center is on the axis of the rotary shaft 11d. Accordingly, the rotary shaft 32 is guided by the guide hole 11g so as to be movable along the circumference of the circle whose center is on the axis of the rotary shaft 11d.

Moreover, the other ends of the sidewalls 33a and 33b are provided with slots 33d and a substantially circular arc-shaped engaging portion 33e. Supporting holes 33f are formed through the sidewalls 33a and 33b in the middle thereof in the longitudinal direction. A supporting shaft 11h standing on the retainer 11 is inserted into the supporting holes 33f so that the clutch arm 33 is rotatably supported. The supporting shaft 11h is provided with an E-ring 37 mounted thereon so as not to be separated from the supporting holes 33f.

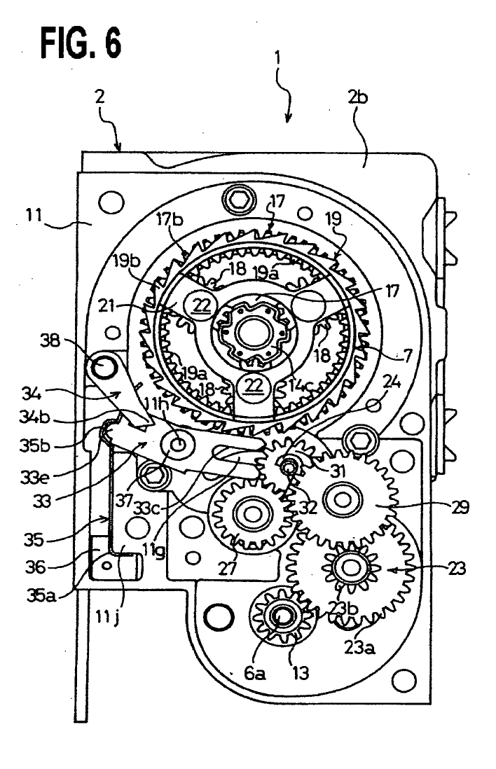

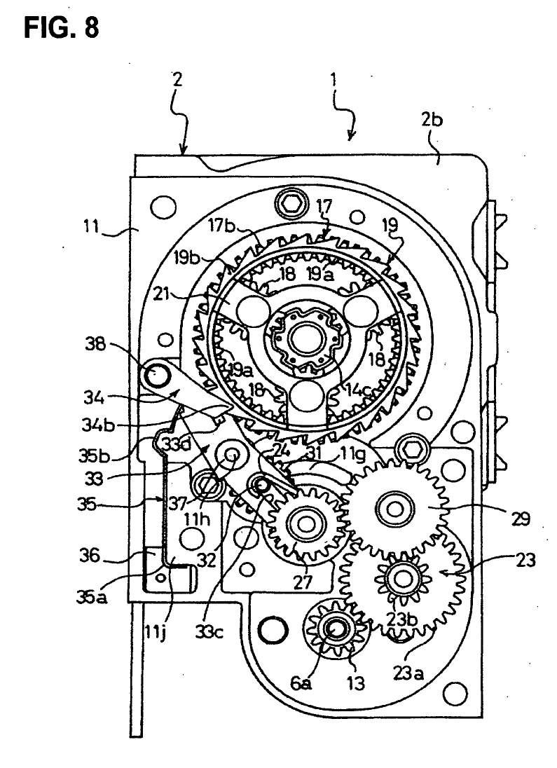

A supporting hole 34a is formed at one end of the clutch pawl 34 while an engaging hook 34b is formed at the other end thereof. In addition, an engaging pin 34c is provided to stand at the other end of the clutch pawl 34, that is, on the side of the engaging hook 34b. The engaging pin 34c is inserted into the slot 33d of the clutch arm 33, can be rotated relative to the clutch arm 33, and can be relatively moved along the slot 33d. As shown in FIG. 6, the clutch pawl 34 is rotatably mounted on the retainer 11 by inserting a pawl pin 38 into a pin hole 11i of the retainer 11 through the supporting hole 34a. Then, as shown in FIG. 8, the engaging hook 34b can be engaged with the ratchet teeth 19b against the clockwise rotation of the ring member 19, which can correspond to the “belt withdrawing direction α”. For this reason, when the engaging hook 34b is engaged with the ratchet teeth 19b, the ring member 19 is not rotated in the clockwise direction.

The resistance spring 35 can be composed of a strip-shaped leaf spring. The resistance spring 35 has a supporting portion 35a, which is formed in an L-shape, at the lower end thereof and a U-shaped recess 35b on the upper portion thereof above the center of the longitudinal axis. A portion of the resistance spring 35 between the recess 35b and the supporting portion 35a is formed in a planar shape. A portion of the resistance spring 35 between the recess 35b and the upper end is formed in a curved shape.

The engaging portion 33e of the clutch arm 33 is engaged with the recess 35b and can be disengaged. As shown in FIG. 6, in a state in which the engaging portion 33e is engaged with the recess 35b, the extending direction of the supporting groove 33c is the tangential direction of the circular arc of the guide hole 11g. Thus, the rotary shaft 32 can be moved from the guide hole 11g to the supporting groove 33c or from the supporting groove 33c to the guide hole 11g.

The spring stopper 36 is formed in an L-shape. The supporting portion 35a is interposed between the spring stopper 36 and a spring mounting portion 11j formed on the retainer 11 so that the resistance spring 35 is supported on the retainer 11 with the upper end thereof as a free end.

Each of the components of the speed reduction mechanisms 7a and 7b, the power transmission mechanism 8, and the power transmission mode switching mechanism 9 is assembled in a recess, which is formed on the opposite side to the surface of the retainer 11 facing the frame 2. After that, a retainer cover 39 is mounted on the opposite side of the retainer 11 with a predetermined number of screws 40 (for example, four are shown in FIG. 3) so as to cover the components.

The power transmission mechanism 8 and the power transmission mode switching mechanism 9, which can have the above-mentioned structure, may be controlled by the ECU 68 to be switched to the following three modes described below. The three modes will be described with reference to FIGS. 6 to 8. FIG. 6 shows a left side view showing a state in which the seat belt retractor is in a power interruption mode. FIG. 7 shows a left side view showing a state in which the seat belt retractor is in a low speed reduction ratio power transmission mode. FIG. 8 shows a left side view showing a state in which the seat belt retractor is in a high speed reduction ratio power transmission mode.

(1) The Power Interruption Mode (Free Mode)

As shown in FIG. 6, in the power interruption mode, the engaging portion 33e of the clutch arm 33 of the power transmission mode switching mechanism 9 is engaged with the recess 35b of the resistance spring 35. In addition, in the state in which the engaging portion 33e is engaged with the recess 35b, since the engaging hook 34b of the clutch pawl 34 is not engaged with the ratchet teeth 19b of the ring member 19, the ring member 19 is freely rotated. For this reason, a torque transmission path (a path for low speed and high torque transmission, as described blow) is interrupted between the sun gear member 20 and the carrier gear 17.

As the rotary shaft 32 comes in contact with the right end of the guide hole 11g, the clutch gear 31 is positioned at the rightmost position. At the rightmost position, the clutch gear 31 is disengaged from the external teeth 17b of the carrier gear 17. For this reason, a torque transmission path (a path for low speed and high torque transmission, as described blow) is interrupted between the clutch gear 31 and the carrier gear 17.

Therefore, the power interruption mode is a mode in which the spool 4 is not connected to the motor 6, the rotational torque of the motor 6 is not transmitted to the spool 4, and the rotational torque of the spool 4 is not transmitted to the motor 6. That is, the power interruption mode can be defined as a disconnected state (which may correspond to a “disconnected state of the power transmission mechanism” of the present disclosure) in which a mechanical connected state (which may correspond to a “connected state of the power transmission mechanism” of the present disclosure) between the spool 4 and the power transmission mechanism 8 is released. In this state, the spool 4 is completely disengaged from the power transmission mechanism 8 (and motor 6), and thus the withdrawal resistance, which is applied to the spool 4 by the power transmission mechanism 8, is lowered. Accordingly, since the spool 4 is easily rotated, the seat belt 3 retracted on the spool 4 is easily withdrawn regardless of the driving or stopping of the motor 6.

(2) The Low Speed Reduction Ratio Power Transmission Mode

As shown in FIG. 7, in the low speed reduction ratio power transmission mode, similar to the power interruption mode, the engaging portion 33e of the clutch arm 33 is engaged with the recess 35b of the resistance spring 35. In addition, in the state in which the engaging portion 33e is engaged with the recess 35b, since the engaging hook 34b of the clutch pawl 34 is not engaged with the ratchet teeth 19b of the ring member 19, the ring member 19 is freely rotated. For this reason, a path for low speed and high torque transmission is interrupted between the sun gear member 20 and the carrier gear 17.

As the rotary shaft 32 is positioned at the uppermost position (a position closest to the rotary shaft of the spool 4) in the middle of the guide hole 11g, the clutch gear 31 is also positioned at the uppermost position (a position closest to the rotary shaft of the spool 4). At the uppermost position, the clutch gear 31 is engaged with the external teeth 17b of the carrier gear 17. For this reason, a path for high speed and low torque transmission is connected between the clutch gear 31 and the carrier gear 17. That is, the motor 6 is connected to the spool 4 through the motor gear 13, the connector gear 23, the idle gear 29, the upper connector gear 27, the lower connector gear 26, the clutch gear 31, the carrier gear 17, and the connector 14. Therefore, the low speed reduction ratio power transmission mode is set. At the uppermost position of the rotary shaft 32, the rotary shaft 32 enters into the supporting grooves 33c of the clutch arm 33 so as to come into contact with the clutch arm 33.

The low speed reduction ratio power transmission mode is a power transmission mode with a low speed reduction ratio in which the path for high speed and low torque transmission is set. In the low speed reduction ratio power transmission mode, it is possible to rapidly retract the seat belt by driving the motor 6. Both the low speed reduction ratio power transmission mode and the high speed reduction ratio power transmission mode can be defined as a connected state in which the spool 4 and the power transmission mechanism 8 are mechanically connected to each other so as to transmit the power of the motor 6 to the spool 4 through the power transmission mechanism 8.

In particular, when the motor 6 is driven and the power transmission mechanism 8 is set to the low speed reduction ratio power transmission mode or the high speed reduction ratio power transmission mode, the power of the motor 6 is transmitted to the spool 4. Furthermore, when the motor 6 is stopped and the power transmission mechanism 8 is set to the low speed reduction ratio power transmission mode or the high speed reduction ratio power transmission mode, high withdrawal resistance is applied to the spool 4 by the power transmission mechanism 8 mechanically connected to the spool 4. Accordingly, it is difficult to withdraw the seat belt 3 from the spool 4 or it is impossible to withdraw the seat belt 3 from the spool 4.

(3) The High Speed Reduction Ratio Power Transmission Mode

As shown in FIG. 8, in the high speed reduction ratio power transmission mode, the engaging portion 33e of the clutch arm 33 is disengaged from the recess 35b of the resistance spring 35 and is positioned at the curved portion, which is formed at the upper end of the resistance spring 35 above the recess 35b. In addition, in the state in which the engaging portion 33e is disengaged from the recess 35b, since the engaging hook 34b of the clutch pawl 34 is engaged with the ratchet teeth 19b of the ring member 19 in the clockwise direction, the ring member 19 is not rotated in the clockwise direction. For this reason, a path for low speed and high torque transmission is connected between the sun gear member 20 and the carrier gear 17. That is, the motor 6 is connected to the spool 4 through the motor gear 13, the connector gear 23, the idle gear 29, the external teeth 20b of the sun gear member 20, the sun gear 20a, the planet gears 18, the carrier gear 17, and the connector 14. Therefore, the power transmission path at a high speed reduction ratio is set by a planetary mechanism.

As the rotary shaft 32 comes in contact with the left end of the guide hole 11g, the clutch gear 31 is positioned at the leftmost position. At the leftmost position, the clutch gear 31 is disengaged from the external teeth 17b of the carrier gear 17. For this reason, a path for high speed and low torque transmission is interrupted between the clutch gear 31 and the carrier gear 17.

In this manner, the high speed reduction ratio power transmission mode is a power transmission mode with high speed reduction ratio in which the path for low speed and high torque transmission is set. In the high speed reduction ratio power transmission mode, the belt is retracted at high tension by driving the motor 6.

Power transmission mode switching among the power interruption mode, the low speed reduction ratio power transmission mode, and the high speed reduction ratio power transmission mode is performed by the power transmission mode switching mechanism 9. For example, the mode switching is performed according to the following patterns.

(1) Power Transmission Mode Switching from the Power Interruption Mode to the Low Speed Reduction Ratio Power Transmission Mode

In the power interruption mode shown in FIG. 6, when the motor 6 is rotated in the normal direction, which may correspond to the clockwise rotation of the motor rotary shaft 6a in FIG. 6 (the belt retracting direction or the direction β in FIG. 3), the lower connector gear 26 and the pulleys 25 are rotated in the direction corresponding to the direction β through the motor gear 13, the connector gear 23, the idle gear 29 and the upper connector gear 27. In this case, the clutch gear 31 runs idle due to the clutch gear 31 not being engaged with the external teeth 17b of the carrier gear 17. Furthermore, since the rotary shaft 32 does not receive resistance, the clutch springs 24 are rotated in the same direction as the pulleys 25. For this reason, the clutch gear 31 and the rotary shaft 32 are moved to the left side along the guide hole 11g. Then, the rotary shaft 32 comes into contact with the clutch arm 33 as shown in FIG. 7.

At the position in which the rotary shaft 32 comes in contact with the clutch arm 33, the clutch gear 31 and the rotary shaft 32 are positioned at the uppermost position mentioned above, and the clutch gear 31 is engaged with the external teeth 17b of the carrier gear 17. For this reason, the torque of the clutch gear 31 is transmitted to the carrier gear 17 and then the carrier gear 17 is rotated. In this case, if there is a slack on the seat belt 3, the seat belt 3 is retracted on the spool 4 by the rotation of the carrier gear 17. If the slack is removed, the spool 4 is not rotated, whereby the carrier gear 17 is also not rotated. For this reason, the clutch gear 31 is also not rotated due to the resistance from the carrier gear 17.

However, since the lower connector gear 26 is rotated by the rotational torque of the motor 6, a force is applied to the rotary shaft 32 toward the leftmost position due to the rotational torque of the lower connector gear 26. In this case, since the rotary shaft 32 comes in contact with the clutch arm 33, the rotary shaft 32 presses the clutch arm 33 due to a pressing force that is generated by the rotary shaft 32. However, at this time, since the tension of the seat belt 3 is smaller than a predetermined value, a moment for rotating the clutch arm 33 in the clockwise direction due to the pressing force of the rotary shaft 32 is smaller than the opposing moment in the clockwise direction due to the engaging force between the engaging portion 33e and the recess 35b. Therefore, the engaging portion 33e is not disengaged from the recess 35b so that the clutch arm 33 is not rotated. Accordingly, the rotary shaft 32 is stopped at the position in which the clutch arm 33 comes into contact with the rotary shaft 32.

With the stopping of the rotary shaft 32, the clutch gear 31 and the rotary shaft 32 are held at the uppermost position described above in FIG. 7. When the clutch gear 31 is held at the uppermost position, the clutch gear 31 is engaged with the external teeth 17b of the carrier gear 17 and the path for high speed and low torque transmission is connected between the clutch gear 31 and the carrier gear 17. Since the clutch arm 33 is not rotated, the clutch pawl 34 is also not rotated so that the engaging hook 34b is held at a position in which the clutch pawl 34 is not engaged with the ratchet teeth 19b. For this reason, the ring member 19 becomes free and the path for low speed and high torque transmission is kept to be disconnected between the sun gear member 20 and the carrier gear 17.

In this manner, the power transmission mechanism 8 is switched from the power interruption mode to the low speed reduction ratio power transmission mode so that the power transmission mechanism 8 is set in the low speed reduction ratio power transmission mode.

(2) Power Transmission Mode Switching from the Low Speed Reduction Ratio Power Transmission Mode to the High Speed Reduction Ratio Power Transmission Mode

The high speed reduction ratio power transmission mode is set through a relatively high rotational torque of the motor 6. In this case, the high speed reduction ratio power transmission mode is set from the power interruption mode through the low speed reduction ratio power transmission mode.

The power interruption mode is switched to the low speed reduction ratio power transmission mode in the same way as described above. However, the tension of the seat belt 3 is larger than the predetermined value at the time of setting the high speed reduction ratio power transmission mode. Accordingly, in the low speed reduction ratio power transmission mode shown in FIG. 7, the moment applied to the clutch arm 33 due to the pressing force of the rotary shaft 32 is larger than the opposing moment in the clockwise direction due to the engaging force between the engaging portion 33e and the recess 35b. Therefore, the engaging portion 33e can be disengaged from the recess 35b.

Accordingly, when the clutch springs 24 are further rotated in the counter-clockwise direction, the rotary shaft 32 rotates the clutch arm 33 about the supporting shaft 11h in the clockwise direction and the rotary shaft 32 is moved to the left side along the guide hole 11g. For this reason, the clutch gear 31 is further moved to the left side. When the rotary shaft 32 comes into contact with the left end of the guide hole 11g, the rotary shaft 32 is not moved further so that the clutch gear 31, the rotary shaft 32, and the clutch springs 24 are stopped. Therefore, as shown in FIG. 8, the clutch gear 31 and the rotary shaft 32 are positioned at the leftmost position. At the leftmost position, the clutch gear 31 is disengaged from the external teeth 17b of the carrier gear 17 so that the path for high speed and low torque transmission is interrupted between the clutch gear 31 and the carrier gear 17.

When the clutch pawl 34 is rotated about the clutch pawl pin 38 in the counter-clockwise direction in conjunction with the rotation of the clutch arm 33, the clutch pawl 34 is placed at a position in which the engaging hook 34b can be engaged with the ratchet teeth 19b as shown in FIG. 8. In this case, since the sun gear member 20 is rotated by the rotational torque of the motor 6 and the ring member 19 is also rotated in the clockwise direction, the ratchet teeth 19b are engaged with the engaging hook 34b. Accordingly, the rotation of the ring member 19 is stopped and the path for low speed and high torque transmission is connected between the sun gear member 20 and the carrier gear 17.

In this manner, the power transmission mechanism 8 is switched from the low speed reduction ratio power transmission mode to the high speed reduction ratio power transmission mode so as to be set in the high speed reduction ratio power transmission mode.

(3) Power Transmission Mode Switching from the High Speed Reduction Ratio Power Transmission Mode to the Power Interruption Mode (Through the Low Speed Reduction Ratio Power Transmission Mode)

In the high speed reduction ratio power transmission mode shown in FIG. 8, when the motor 6 is rotated in the reverse direction, which corresponding to the counter-clockwise rotation of the motor rotary shaft 6a in FIG. 6 (the belt withdrawing direction or the direction α in FIG. 3), the lower connector gear 26 and the pulleys 25 are rotated in the direction opposite to the direction mentioned above. Since the clutch springs 24 are also rotated in the direction opposite to the direction mentioned above, the clutch gear 31 and the rotary shaft 32 are moved to the right side along the guide hole 11g while the clutch arm 33 is rotated in the counter-clockwise direction.

Since the clutch pawl 34 is rotated in the clockwise direction in conjunction with the counter-clockwise rotation of the clutch arm 33, the clutch pawl 34 is positioned at a disengaging position, and thus is not engaged with the ratchet teeth 19b. Therefore, the ring member 19 is freely rotated and the path for low speed and high torque transmission is interrupted.

When the clutch gear 31 and the rotary shaft 32 are positioned at the uppermost position mentioned above, the clutch gear 31 is engaged with the external teeth 17b of the carrier gear 17 so as to be temporarily in the low speed reduction ratio power transmission mode shown in FIG. 7. However, since the clutch gear 31 and the rotary shaft 32 are continuously moved to the right side, the clutch gear 31 is disengaged from the external teeth 17b and runs idle. Accordingly, the path for high speed and low torque transmission is temporarily connected but it is immediately interrupted. In addition, when the path for high speed and low torque transmission is temporarily connected, the spool 4 is temporarily rotated in the belt withdrawing direction α but it is immediately stopped due to the reverse rotation of the motor 6.

When the rotary shaft 32 comes into contact with the right end of the guide hole 11g, the rotary shaft 32 is not moved further so that the clutch gear 31, the rotary shaft 32, and the clutch spring 24 are stopped. Therefore, the clutch gear 31 and the rotary shaft 32 are positioned at the rightmost position shown in FIG. 6.

In this manner, the power transmission mechanism 8 is switched from the high speed reduction ratio power transmission mode to the power interruption mode so that the power transmission mechanism 8 is set in the power interruption mode.

In the above-mentioned embodiment, the power transmission mechanism 8 is switched by controlling the rotation of the motor 6.

Specifically, in the low speed reduction ratio power transmission mode, the motor 6 is controlled so as to be rotated in the normal direction so that the power interruption mode is switched to the low speed reduction ratio power transmission mode and then the low speed reduction ratio power transmission mode is continued. On the other hand, the motor 6 is also controlled to be rotated in the reverse direction so that the low speed reduction ratio power transmission mode is switched to the power interruption mode. Thus, the low speed reduction ratio power transmission mode is released. In this case, when the motor 6 is controlled so as to be rotated in the reverse direction so that the power transmission mechanism 8 is switched from the connected state (the low speed reduction ratio power transmission mode) to the disconnected state (the power interruption mode), the power transmission mechanism 8 is switched from the connected state (the low speed reduction ratio power transmission mode) to the disconnected state (the power interruption mode) by a rotational speed difference between the motor 6 and the spool 4.

In addition, in the high speed reduction ratio power transmission mode, the motor 6 is controlled so as to be rotated in the reverse direction so that the low speed reduction ratio power transmission mode is switched to the high speed reduction ratio power transmission mode and then the high speed reduction ratio power transmission mode is continued. On the other hand, the motor 6 is also controlled so as to be rotated in the normal direction so that the high speed reduction ratio power transmission mode is switched to the low speed reduction ratio power transmission mode. Thus, the high speed reduction ratio power transmission mode is released.

Furthermore, the seat belt retractor 1 of the present application may have the following seven modes for the seat belt 3.

(1) Belt Storage Mode

The belt storage mode is a mode in which the seat belt 3 is not used and fully retracted on the spool 4. In the belt storage mode, the motor 6 of the seat belt retractor 1 is not driven and the power transmission mechanism 8 is set in the power interruption mode. Thus, a very small belt tension acts on the seat belt 3 (which will be described in the description of a belt retracting mode to be described below) and the power consumption is zero.

(2) Belt Withdrawing Mode

The belt withdrawing mode is a mode in which the seat belt 3 is withdrawn from the spool 4 so that it can be fastened. In the belt withdrawing mode, the seat belt retractor 1 is set in the power interruption mode. Thus, a small force is enough for withdrawing the seat belt 3. In this mode, the motor 6 is not driven and the power consumption is zero.

(3) Belt Retracting Mode for Fitting

The belt retracting mode for fitting is a mode in which an excessively withdrawn amount of the seat belt 3 is retracted to fit the seat belt 3 about an occupant. The belt retracting mode is operated after the seat belt 3 is withdrawn and the tongue (for example, the tongue 62 in FIG. 1) is inserted into and latched with the buckle to turn on the buckle switch (for example, the buckle switch 66a in FIG. 1) or when the occupant moves from the normal-use state of the seat belt 3 (buckle switch is ON) in which a predetermined amount of the seat belt 3 is withdrawn and then the occupant returns to the normal-use state. In the belt retracting mode for fitting, the motor 6 of the seat belt retractor 1 is driven in the belt retracting direction and the power transmission mechanism 8 is set in the low speed reduction ratio power transmission mode. Therefore, the seat belt 3 is rapidly retracted with low torque and the motor 6 is stopped at the time a very small belt tension occurs so that the seat belt 3 is fastened about the occupant.

(4) Normal Fastening Mode (Comfort Mode)

The normal fastening mode (also known as the “comfort mode”) is a mode in which the seat belt 3 is in the normal fastening state and it is set after the completion of the belt retracting mode for fitting. In the normal fastening mode, the motor 6 of the seat belt retractor 1 is not driven and the power transmission mechanism 8 is set in the power interruption mode. Thus, since very small tension acts on the seat belt 3, the occupant does not feel discomfort even when fastening the seat belt 3. In addition, the power consumption is zero.

(5) Warning Mode

The warning mode is a mode in which there is a detection of the driver dozing off or of an obstacle in front of the vehicle during the drive of the vehicle in the normal fastening mode. In response to the detection, the retracting action of the seat belt 3 is repeated a predetermined number of times so as to warn the driver. In the warning mode, the motor 6 of the seat belt retractor 1 is set to drive repeatedly.

Thus, a relatively large tension, which is smaller than the belt tension in an emergency mode to be described below, and a very small tension are alternately applied to the seat belt 3 so that the driver is warned about the dozing off of the driver or the obstacle in front of the vehicle.

(6) Emergency Mode

The emergency mode is a mode that occurs when the vehicle is in high danger of colliding with an obstacle during the drive of the vehicle in the normal fastening mode. This mode has two stages that are described as follows.

(i) Initial Stage

In the initial stage of the emergency mode, the motor 6 of the seat belt retractor 1 is rotated in the normal direction with a relatively high rotational torque. Accordingly, the clutch springs 24 are rotated in the power interruption mode so that the clutch gear 31 and the rotary shaft 32 are moved to the uppermost position. Then, the clutch gear 31 is engaged with the external teeth 17b of the carrier gear 17. At this moment, the slack of the seat belt 3 is removed and the tension of the seat belt 3 becomes smaller than a predetermined value. Accordingly, the resistance from the carrier gear 17 to the clutch gear 31 is relatively small. For this reason, even though the rotational torque of the motor 6 is relatively high, the rotary shaft 32 does not rotate the clutch arm 33. Therefore, the power transmission mechanism 8 is set in the low speed reduction ratio power transmission mode. As a result, the torque of the clutch gear 31 is transmitted to the carrier gear 17 to rotate the carrier gear 17. Thus, the seat belt 3 is rapidly withdrawn with the low torque to rapidly remove the slack of the seat belt 3.

(ii) Late Stage

When the slack of the seat belt 3 is removed in the initial stage, the emergency mode proceeds to the late stage from the initial stage. In the late stage, as the tension of the seat belt 3 exceeds the predetermined value, the resistance applied to the clutch gear 31 from the carrier gear 17 becomes relatively large. Accordingly, the carrier gear 17 and the clutch gear 31 are not rotated. However, since the lower connector gear 26 is to be rotated by the rotational torque of the motor 6, force is applied to the rotary shaft 32 in the direction toward the leftmost position by the rotational torque of the lower connector gear 26. In this case, since the rotational torque of the motor 6 is relatively high, the moment for rotating the clutch arm 33 in the clockwise direction by the pressing force of the rotary shaft 32 is larger than the opposing moment in the clockwise direction by the engaging force between the engaging portion 33e and the recess 35b. Therefore, the engaging portion 33e of the clutch arm 33 is disengaged from the recess 35b of the resistance spring 35. Then, the rotary shaft 32 is moved to the leftmost position while rotating the clutch arm 33. Since the clutch pawl 34 is rotated in conjunction with the rotation of the clutch arm 33, the engaging hook 34b of the clutch pawl 34 is engaged with the ratchet teeth 19b so that the ring member 19 is not rotated. For this reason, the power transmission mechanism 8 is set in the high speed reduction ratio power transmission mode. Therefore, the seat belt 3 is retracted with high torque so as to restrain the occupant with an extremely large belt tension.

(7) Belt Retracting Mode for Storage

The belt retracting mode for storage is a mode in which the seat belt 3 is fully retracted so as to be stored when the buckle switch is turned off by pulling out the tongue (for example, the tongue 62 in FIG. 1) from the buckle for taking off the seat belt 3. In the belt retracting mode for storage, the motor 6 of the seat belt retractor 1 is driven in the belt retracting direction with relatively low rotational torque and the power transmission mechanism 8 is set in the low speed reduction ratio power transmission mode. Therefore, the seat belt 3 is rapidly retracted with low torque.

Then, the seat belt 3 is fully retracted and the motor 6 is stopped at the time of a very small belt tension occurs so that the seat belt 3 is set in the belt storage mode with very small belt tension on the seat belt 3.

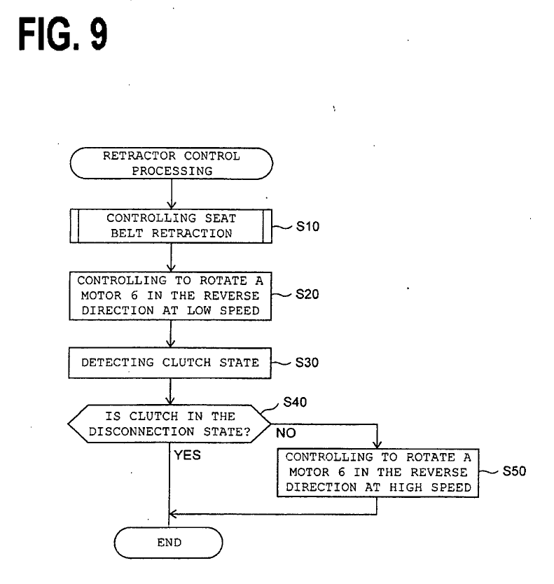

In the belt retracting mode for storage, the motor 6 is controlled to be rotated in the reverse direction so that the power transmission mechanism 8 is switched from the connected state (the low speed reduction ratio power transmission mode) to the disconnected state (the power interruption mode) after the retraction of the seat belt 3 for storage. In this case, the power transmission mechanism 8 is switched from the connected state (the low speed reduction ratio power transmission mode) to the disconnected state (the power interruption mode) by the rotational speed difference between the motor 6 and the spool 4. In the present embodiment, when the power transmission mechanism 8 is switched from the connected state to the disconnected state, the motor 6 is controlled to be rotated in the reverse direction at low speed in order to reduce the operational sound caused by the idle running of the motor 6. Since a control unit (for example, the ECU 68 in FIGS. 1 and 2) performs, for example, the “retraction control process” shown in FIG. 9, the motor can be controlled. A flow chart of the retraction control process according to an embodiment of the present invention is shown in FIG. 9.

First, the retraction control (or the storage control) of the seat belt is performed in the step S10 of the retraction control process shown in FIG. 9. In the retraction control of the seat belt, the motor 6 is controlled to be rotated in the normal direction so that the power transmission mechanism 8 is set in the low speed reduction ratio power transmission mode. Then, the withdrawn seat belt 3 is rapidly retracted (or stored) on the spool 4 with low torque. In this case, a “first direction” may correspond to a normal rotational direction in which the motor 6 is rotated to retract the seat belt 3 on the spool 4.

Next, in the step S20, the motor 6 is controlled to be rotated in the reverse direction at low speed so that the power transmission mechanism 8 is switched from the connected state (the low speed reduction ratio power transmission mode) to the disconnected state (the power interruption mode). The reverse rotational direction of the motor 6 may correspond to a “second direction opposite to the first direction.” In this case, the low speed of the motor 6 is defined as a speed useful in reducing the operational sound that is caused by the switching operation of the power transmission mechanism 8 and that can be properly set in accordance with the assumed operational sound level. The low speed may correspond to “operational sound reducing speed.” Accordingly, it is possible to reduce the operational sound when the power transmission mechanism 8 is switched from the connected state (the low speed reduction ratio power transmission mode) to the disconnected state (the power interruption mode). In addition, the operational sound reducing speed may have a specific speed value or may have any speed values within a predetermined speed range.

In the switching operation of the power transmission mechanism 8 in the step S20, it is assumed that the occupant applies a tensile force to the seat belt 3 and thus the spool 4 is rotated in the belt retracting direction. In this case, since the rotational speed difference between the motor 6 and the spool 4 does not sometimes occur, the power transmission mechanism 8 is not sometimes switched from the connected state (the low speed reduction ratio power transmission mode) to the disconnected state (the power interruption mode).

Consequently, in a step S30, the state (which may be referred to as a “clutch state”) of the power transmission mechanism 8 is detected so as to confirm whether the switching operation of the power transmission mechanism 8 is completed in the step S20. Specifically, when the motor 6 is operated, a motor current value is detected or measured. Then, the determination of whether the power transmission mechanism 8 is in the connected state or the disconnected state is determined on the basis of the motor current value. The motor current value is detected by the motor current detector 69, which may correspond to a “detecting unit” or a “motor ammeter,” shown in FIG. 2.

If the motor current value detected in the step S30 is larger than a specified value (which may correspond to a “reference current value”), the load of the motor is relatively high. Accordingly, in a step S40, it is determined that the power transmission mechanism 8 is in the connected state (the clutch connected state or the “NO” path in the step S40) and the procedure proceeds to a step S50. In the meantime, if the motor current value detected in the step S30 is smaller than the specified value, it is determined that the power transmission mechanism 8 is in the disconnected state (the clutch disconnected state or the “YES” path in the step S40) where the load of the motor is relatively low and the procedure is directly terminated. The specified value (the reference current value) is properly set on the basis of the motor current value when the power transmission mechanism 8 is in the connected state or the motor current value when the power transmission mechanism 8 is in the disconnected state.

In a step S50, the motor 6 is controlled to be rotated in the reverse direction at a higher speed than the speed in the step S20 so that the power transmission mechanism 8 is completely switched to the disconnected state (the power interruption mode). The higher speed may correspond to a “speed higher than the operational sound reducing speed.” Accordingly, it is possible to reliably switch the power transmission mechanism 8 to the disconnected state (the power interruption mode).

According to the seat belt retractor 1 of the present embodiment, if at least the step S10 and the step S20 are performed for the retraction control process shown in FIG. 9, it is possible to reduce the operational sound that is caused by the disconnection operation of the power transmission mechanism 8. Accordingly, the present invention could be performance of the control corresponding to at least the step S10 and the step S20 are performed.

Further, it can be possible to reduce the operational sound that is caused by the disconnection operation of the power transmission mechanism 8 by performing the steps S30 to S50. Furthermore, after it is assumed that the occupant applies a tensile force to the seat belt 3, and thus the spool 4 is rotated in the belt withdrawing direction, it is possible to reliably perform the disconnection operation of the power transmission mechanism 8.

In addition, according to one embodiment of the seat belt retractor 1, the motor current detector 69 for detecting the current value of the motor 6 is used as a unit for detecting whether the power transmission mechanism 8 is in the connected state or the disconnected state. Therefore, it is possible to simplify the structure thereof.

Moreover, according to another embodiment of the seat belt retractor 1, since the two power transmission paths are set in the power transmission mechanism 8, it is possible to achieve two retracting performances that include rapid retraction of the seat belt for removing the slack of the seat belt 3 and the retraction of the seat belt with high torque for restraining the occupant. The two power transmission paths include the low speed reduction ratio power transmission mode that is caused by the path for the high speed and low torque transmission and the high speed reduction ratio power transmission mode that is caused by the path for the low speed and high torque transmission.

Since the torque of the motor 6 is efficiently transmitted to the spool 4 by the two power transmission paths, it is possible to rapidly achieve the two retracting performances with limited power consumption. In addition, since the retraction of the seat belt with high torque is performed by the path for the low speed and high torque transmission, it is possible to reduce the rotational torque of the motor 6 as compared with other devices in the related art. For this reason, it is possible to reduce the power consumption of the motor 6 and to use a smaller motor, thereby making the seat belt retractor 1 more compact.

Moreover, since the above-mentioned two retracting performances can be achieved, the seat belt retractor 1 can have a pre-tensioning function using the rotational torque of the motor 6. Therefore, it is possible to eliminate a pre-tensioner using a reaction gas for the seat belt retractor as used in the related art, thereby reducing the manufacturing cost thereof.

In addition, the power transmission mechanism 8 may be set in the low speed reduction ratio power transmission mode or the high speed reduction ratio power transmission mode according to the tension of the seat belt 3. Accordingly, it can be easy to switch the modes without controlling the rotational torque of the motor 6.

Furthermore, the power transmission mechanism 8 may have a power interruption mode in which the rotational torque of the motor 6 is not transmitted to the spool.

Accordingly, the withdrawing of the seat belt 3, the normal fastening of the seat belt 3 without discomfort for the occupant, and the storage of the seat belt 3 when not in use can be performed regardless of the motor 6.

In addition, since the retracting operation of the seat belt 3 for storage can be performed only by the rotational torque of the motor 6, it is possible to eliminate or reduce the urging force without an additional module such as a tension reducer. The urging force may be caused by the retracting element, such as a spiral spring, and the urging force always acts on the seat belt 3 in the belt retracting direction.

In this case, even though the urging force by the retracting element is set in a minimum range for fitting the seat belt 3 to the occupant when the occupant puts on the seat belt 3, it is possible to reliably retract the seat belt 3 for storage so as to assist the retracting of the seat belt 3 by transmitting the torque of the motor 6 to the spool 4 in the low speed reduction ratio power transmission mode.

Since the high reduction ratio mechanism 7a can be formed of the planetary mechanism, the path for low speed and high torque transmission can be made compact. For this reason, even though the power transmission mechanism 8 has both the low speed reduction ratio power transmission mode and the high speed reduction ratio power transmission mode, it is possible to effectively reduce the size of the seat belt retractor 1.

Furthermore, since a carrier of the high reduction ratio mechanism 7a and the external teeth 17b of the low reduction ratio mechanism 7b can be formed of a single common carrier gear 17, the number of parts can be reduced, thereby making the seat belt retractor compact.

In addition, the power transmission mode switching mechanism 9 can control the rotation of the internal gear 19a of the planetary mechanism and the engagement between the small diametric clutch gear 31 and the external teeth 17b of the large diametric carrier gear 17 according to the tension of the seat belt 3, thereby making it easy to switch the power transmission modes.

The invention is not limited to the embodiments listed above and may have various applications and modifications. For example, there may be other embodiments as provided below.

In one embodiment, a sensor, such as a hall IC, can be used instead of the motor current detector 69 as a unit for detecting whether the power transmission mechanism 8 is in the connected state or the disconnected state. Specifically, in the case of a structure using the hall IC, it is possible to employ a structure for monitoring the state of the clutch by using a magnetic element (a magnet) and a magnetic hall sensor (the hall IC) in conjunction with the operation of the clutch.

Although the structure of the seat belt retractor 1 to be mounted on a vehicle is disclosed, the retractor according to another embodiment of the present embodiment can be used in a seat belt device mounted on the vehicle for transporting occupants, for example, an automobile, an airplane, a ship, an electric train, etc. and can be properly used in a seat belt device for retracting a seat belt by a seat belt motor to restrain the occupants.

The priority application Japanese Patent Application No. 2005-117121, filed Apr. 14, 2005, is incorporated by reference herein.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A seat belt retractor comprising:
a spool for retracting and withdrawing a seat belt;
an electric motor;
a power transmission mechanism that is interposed between the electric motor and the spool, wherein the power transmission mechanism is configured to form a connected state in which the electric motor and the spool are connected to each other and a disconnected state in which the connected state is released; and
a control unit for controlling the electric motor and the power transmission mechanism,
wherein the spool is configured to be controlled to rotate in a seat belt retracting direction so as to retract the seat belt in the connected state of the power transmission mechanism when the electric motor is driven to be rotated in a first direction, and
wherein the control unit is configured to control the electric motor so that the electric motor is rotated in a second direction at an operational sound reducing speed when the power transmission mechanism is switched from the connected state to the disconnected state.

2. The seat belt retractor according to claim 1, wherein the power transmission mechanism is configured to be switched from the connected state to the disconnected state by a rotational speed difference between the electric motor and the spool when the electric motor is driven to be rotated in the second direction so as to switch the power transmission mechanism from the connected state to the disconnected state.

3. The seat belt retractor according to claim 1, further comprising a detecting unit for detecting whether the power transmission mechanism is in the connected state or the disconnected state.

4. The seat belt retractor according to claim 3, wherein, after the control unit controls the electric motor so that the electric motor is rotated in the second direction at the operational sound reducing speed, the control unit is configured to control the electric motor so that the electric motor is rotated in the second direction at a higher speed than the operational sound reducing speed when the control unit has determined that the power transmission mechanism is in the connected state on the basis of the detecting by the detecting unit.

5. The seat belt retractor according to claim 3, wherein the detecting unit includes a motor current detector for detecting a current value of the electric motor.

6. The seat belt retractor according to claim 5, wherein the control unit is configured to determine that the power transmission mechanism is in the connected state when the current value detected by the motor current detector is larger than a reference current value.

7. A seat belt device comprising:
a seat belt for fastening about a vehicle occupant; and
a seat belt retractor, wherein the seat belt retractor comprises:
a spool for retracting and withdrawing a seat belt;
an electric motor;
a power transmission mechanism that is interposed between the electric motor and the spool, wherein the power transmission mechanism is configured to form a connected state in which the electric motor and the spool are connected to each other and a disconnected state in which the connected state is released; and
a control unit for controlling the electric motor and the power transmission mechanism,
wherein the spool is configured to be controlled to rotate in a seat belt retracting direction so as to retract the seat belt in the connected state of the power transmission mechanism when the electric motor is driven to be rotated in a first direction, and
wherein the control unit is configured to control the electric motor so that the electric motor is rotated in a second direction at an operational sound reducing speed when the power transmission mechanism is switched from the connected state to the disconnected state.

8. The seat belt device according to claim 7, wherein the power transmission mechanism is configured to be switched from the connected state to the disconnected state by a rotational speed difference between the electric motor and the spool when the electric motor is driven to be rotated in a second direction opposite to the first direction so as to switch the power transmission mechanism from the connected state to the disconnected state.

9. The seat belt device according to claim 7, further comprising a detecting unit for detecting whether the power transmission mechanism is in the connected state or the disconnected state.

10. The seat belt device according to claim 9, wherein, after the control unit controls the electric motor so that the electric motor is rotated in the second direction at the operational sound reducing speed, the control unit is configured to control the electric motor so that the electric motor is rotated in the second direction at a higher speed than the operational sound reducing speed after determining that the power transmission mechanism is in the connected state on the basis of the detecting by the detecting unit.

11. The seat belt device according to claim 9, wherein the detecting unit includes a motor current detector for detecting a current value of the electric motor.

12. The seat belt device according to claim 11, wherein the control unit is configured to determine that the power transmission mechanism is in the connected state when the current value detected by the motor current detector is larger than a reference current value.

13. A seat belt retractor comprising:
a spool for retracting and withdrawing a seat belt;
an electric motor;
a power transmission mechanism in operational contact with the electric motor and the spool, wherein the power transmission mechanism is configured to form a connected state in which the electric motor and the spool are connected to each other and a disconnected state; and
a control unit for controlling the electric motor and the power transmission mechanism,
wherein the control unit is configured to control the electric motor so that the electric motor is rotated in a direction at an operational sound reducing speed when the power transmission mechanism is switched from the connected state to the disconnected state.
